(19) United States
(12) Patent Application Publication
(10) Pub. No.: US 2011/0094894 A1
(43) Pub. Date: Apr. 28, 2011

(54) GENERATION OF HYDROGEN ON DEMAND

(76) Inventor: Dennis B. Mason, Sandy, UT (US)

(21) Appl. No.: 12/606,158

(22) Filed: Oct. 26, 2009

(51) Int. Cl. C25B 1/02; C25B 9/00; H01M 8/18; B01J 19/00; F02B 43/00

(52) U.S. Cl. 205/637; 204/241; 422/119; 123/3; 429/418

(57) ABSTRACT

The methods and systems for producing hydrogen on demand use aluminum, a heat source and an electrical source, such as, but not limited to, solar power. The heat source and electrical source is used to produce chemical intermediates from sodium chloride via electrolysis. The chemical intermediates from the sodium chloride may be reacted with aluminum to produce hydrogen. The on-demand hydrogen systems can generate a continuous stream of hydrogen that can power a home or business. Alternatively, or in addition, the on-demand hydrogen system can be incorporated into a vehicle to power the vehicle.

### BACKGROUND OF THE INVENTION

1. The Field of the Invention

The present invention relates to the production of hydrogen on demand.

2. The Relevant Technology

Energy is an essential component to modern society. Mankind relies heavily on electricity, petroleum distillates, and natural gas for heating and powering homes and for transportation. Electricity for use in homes is often obtained from burning coal or natural gas in large power plants using heat and electrical turbines or from water reservoirs and dams. The electrical power is then transported to homes and business over a “grid” system.

Engineers design transmission networks to transport the energy as efficiently as feasible, while at the same time taking into account economic factors, network safety and redundancy. These networks use components such as power lines, cables, circuit breakers, switches and transformers. The networks are subject to natural storms in remote locations, which cause intermittent loss of electrical power to consumers.

Transmission efficiency is improved by increasing the alternating current, AC, voltage using a step-up transformer, which reduces the current in the conductors, while keeping the power transmitted nearly equal to the power input. The reduced current flowing through the conductor reduces the heat losses in the conductor and since, according to Joule's Law, the losses are proportional to the square of the current. Halving the current makes the transmission loss one quarter the original value.

The capital costs and man-power associated with designing and maintaining a system of power stations and transmission lines is very high. Consequently, electrical power generation has become highly specialized and consolidated in large corporations. The grid system for distributing power has proved adequate for many large urban centers where local power generation is not feasible. However, the economies of scale do not favor power generation in smaller populations and/or remote locations. In smaller populations and/or remote locations, the infrastructure for delivering the power becomes an increasingly larger percentage of the total cost of power production.

Moreover, the consolidation and specialization of the power industry has positioned some large power producers to charge excessive rates to deliver power to small populations and/or remote locations. In small populations and particularly with remote locations, the high capital costs prohibit redundant power lines. Thus, established power producers have no competition and can be in a position to take advantage of consumers.

Another, problem with the current grid system for production and distribution of power is that it is a highly inefficient use of natural resources. The grid system is efficient at generating power, but is inefficient at distributing power. Thus, the inefficiencies of the current grid system are particularly stark for more remote locations. These inefficiencies also result in excess carbon dioxide emissions which may be contributing to global climate change and which is currently a pressing issue.

Yet another problem with the current grid system is that electrical power and transportation fuels are distributed in two completely separate systems. In general, transportation fuels are provided by petroleum distillates, which are distributed to local outlets via rail or truck lines.

What is needed is a source of energy production that can create competition in the highly monopolistic energy sector while reducing the environmental impact that the current antiquated system imposes on our environment. A second need is to restore independence to small groups, farmers, families, etc., which could also lead to financial independence from the stock market, financial, institutions and power distributers.

### BRIEF SUMMARY OF THE INVENTION

The present invention relates to methods and systems for producing hydrogen on demand. The on-demand hydrogen systems can generate a continuous stream of hydrogen that can power a home or business or any kind of vehicle. A home operated electrical generator can produce income when connected to the grid.

The systems and methods of the invention use aluminum and a heat source and/or electrical source such as, but not limited to, wood products, wind, hydro-electric, solar collectors and/or solar cells to produce hydrogen on demand. The Aluminum can be discarded as waste aluminum or recycled to make more solid aluminum using techniques known in the art. The solar power is used to produce chemical intermediates from sodium chloride via electrolysis (this aspect of the invention is described in more detail below). The chemical intermediates from the sodium chloride are reacted with aluminum to produce hydrogen. The system advantageously smoothes out the variability in a heat source such as solar energy by allowing temporary storage and portability, that is, easily and safely moved and carried, sodium chloride electrolysis products. The system also provides for an emergency source of the sodium chloride electrolysis products.

It is well-recognized that solar power alone typically produces insufficient energy density to power a vehicle or residential home at peak power demand. In the systems and methods of the invention, aluminum provides the majority of the chemical potential for producing power. Solar power is used to produce reactants (i.e., the sodium chloride electrolysis products) that when reacted with aluminum unleash its chemical potential. The system provides ample energy to power a vehicle or home. In addition, the sodium chloride intermediates may be produced on demand, which allows these reactants to be stored in reasonable quantities. The on demand production of the reactants minimizes the hazards of these compounds and improves safety. The Aluminum reaction also produces several times more hydrogen than was produced initially in the electrolysis without additional energy added to the system.

In addition to smoothing out solar fluctuations and increasing the total output, the systems and methods of the invention advantageously avoid the need to store large quantities of hydrogen. It has been long recognized that hydrogen is a very desirable energy carrier. There are currently many initiatives to move toward a hydrogen economy. One of the principle obstacles with using hydrogen as an energy carrier is its safety. Hydrogen gas is flammable in air if present in a concentration greater than about 5% and explosive in concentrations greater than about 18%, even if there is no ignition source present. Thus, hydrogen gas can pose a substantial safety risk if found in high concentrations.

In addition, hydrogen fuel is a gas, which means that its volume is high and storage tanks for hydrogen are usually large and heavy. To reduce the volume of the gas, hydrogen can be compressed. However, compressing the hydrogen increases the risk that the hydrogen will escape or that damage to the tank will result in an explosion. Liquid hydrogen is extremely cold, which complicates handling, and periodically the volumes of hydrogen must be released to the atmosphere which lowers the temperature of the remaining hydrogen, which is wasteful and reduces the efficiency of the system.

Despite enormous amounts of resources being spent on improving the power density of hydrogen, it appears that there are currently no commercially feasible options for on-board storage of hydrogen in sufficient quantities to power a typical vehicle. While stationary storage mechanisms are more reasonable, a hydrogen economy would require distributing the hydrogen, which thus far has typically relied on vehicle transportation.

The present invention avoids the disadvantages of storing hydrogen by producing the hydrogen on demand. While the systems and methods of the present invention may use a hydrogen storage tank, hydrogen storage is not essential and the volume and pressures within a hydrogen storage tank can be substantially reduced as compared to systems and methods that utilize traditional fuelling stations.

In one embodiment, the invention includes a system for generating hydrogen on demand. The system includes a source of a salt material that includes sodium chloride, a heating apparatus capable of generating sufficient heat to melt the salt material; an electrolysis vessel configured to receive melted salt material, the electrolysis vessel including electrodes coupled to a power source and configured to perform electrolysis of the sodium chloride to produce sodium metal and chlorine gas; a first mixing chamber configured to receive water and sodium metal to produce hydrogen and sodium hydroxide; a second mixing chamber configured to receive water, the hydrogen gas and the chlorine gas to produce hydrochloric acid. The system also includes a source of aluminum that can be delivered to a hydrogen production apparatus. The hydrogen production apparatus includes, a first production chamber configured to receive and react aluminum and sodium hydroxide to form hydrogen and AlNa(OH)₄; a second production chamber configured to receive and react aluminum and hydrochloric acid to form hydrogen and AlCl₃. The hydrogen production system includes a hydrogen flow system for delivering the hydrogen to a power generating apparatus.

The foregoing system can be incorporated into a stationary system to power a home or business. Alternatively, the foregoing system can be incorporated into a mobile system such as a car, truck, or other vehicle.

The power generating apparatus can be any power generating apparatus that can convert hydrogen to useful work or energy. In one embodiment, the power generating apparatus can be a combustion engine configured to power a vehicle or an electrical generator. In an alternative embodiment, the power generating apparatus may be a fuel cell configured to directly convert the hydrogen (and oxygen from the air) into electrical power. In both cases, the power generating apparatus emits no carbon dioxide as the only byproduct is pure unpolluted water vapor, which can be condensed and used as drinkable water.

The present invention is also directed towards a method for producing hydrogen on demand. In one embodiment, the method includes melting a salt material that includes sodium chloride; performing electrolysis of the melted material to produce sodium metal, hydrogen, and chlorine gas; reacting the sodium metal with water to produce sodium hydroxide; reacting the chlorine gas and hydrogen with water to produce hydrochloric acid; in a first chamber, reacting aluminum with the sodium hydroxide to form hydrogen and AlNa(OH)₄; in a second chamber, reacting aluminum with the hydrochloric acid to form hydrogen and AlCl₃; and recovering more than the original amount of the hydrogen. The methods of the invention can be used to produce hydrogen at desired rates over time.

In yet another embodiment, the present invention is directed to an apparatus configured to store sodium metal and produce sodium hydroxide on demand. The apparatus can be used in the systems and methods described herein for on-demand control of hydrogen gas production. In one embodiment, the vessel includes a sodium module including a plurality of elongate channels, each channel having a first end and a second end and sodium metal disposed in discrete modules therein; a reaction vessel including water and being in fluid communication with the second opening of at least one elongate channel; a dispensing apparatus operably coupled to the first opening of the at least one elongate channel, wherein the dispensing apparatus is operable to inject a measured quantity of sodium from the elongate channel into the measured water of the reaction vessel so as to produce a measured quantity of sodium hydroxide in the reaction vessel. The reason the sodium and water volumes are measured is because the resultant hydrogen must also be delivered in quantities on demand with minimal waste.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a schematic of a system for generating hydrogen;

FIG. 1B illustrates a schematic of a system incorporating the system of FIG. 1A;

FIG. 2A illustrates an apparatus for producing sodium hydroxide

FIG. 2B is a side cut away view of a portion of the apparatus of FIG. 2A;

FIG. 3 is a flow diagram of a method for producing hydrogen on demand; and

FIG. 4 is a flow diagram of an alternative method for producing hydrogen on demand.

### DETAILED DESCRIPTION

The methods and systems for producing hydrogen on demand use aluminum, a heat source and a power source such as, but not limited to, solar collectors, wood pellets and etc. The heat source and power source are used to produce chemical intermediates from sodium chloride via electrolysis. The chemical intermediates from the sodium chloride may be reacted with aluminum to produce hydrogen. The on-demand hydrogen systems can generate a continuous stream of hydrogen that can power a vehicle, generator, home or business. Surplus hydrogen or the energy derived there from can be used to make more sodium, chlorine, or power generators to make electricity to be sold for profit back into the power grid.

A vehicle, motor, fuel cell, a hydrogen flame, or any device requiring hydrogen can utilize the present invention to supply hydrogen. A low pressure activating valve may be used to control hydrogen on demand. When a low pressure is detected the valve controls the system to supply more hydrogen. For example, an inexpensive carburetor on an internal combustion engine may be used to create a vacuum on the first part of the engine cycle. In this embodiment, when the intake valve opens, the piston starts moving down into the cylinder to suck air and fuel into the cylinder. This vacuum, (i.e., low or negative pressure) signals the low pressure valve to open, hydrogen and air would then enter the engine to keep it running. The foregoing example illustrates how “Demand” for hydrogen may be detected and met using the systems described herein.

I. Systems for Generating Hydrogen

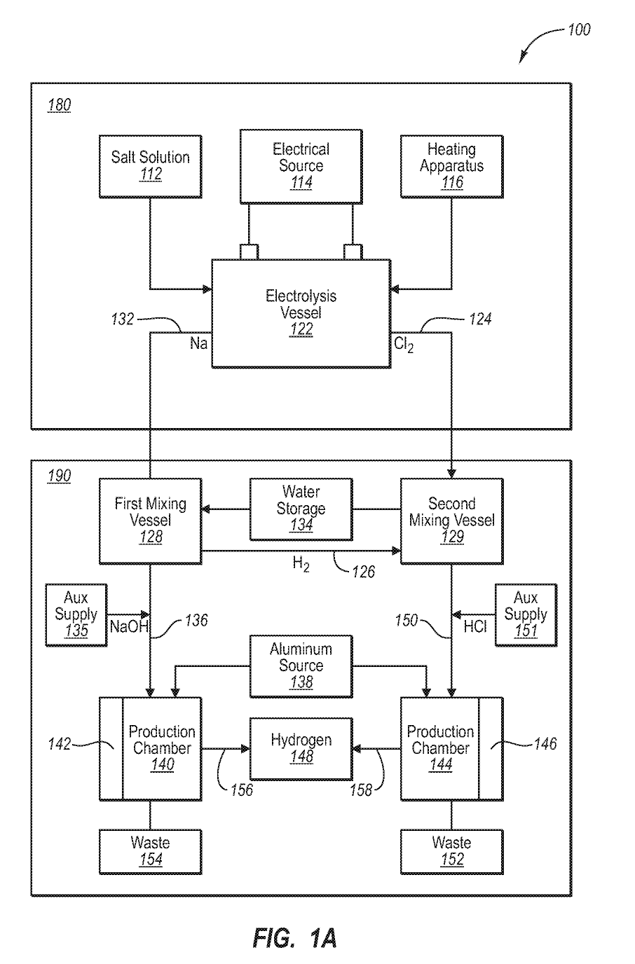

FIG. 1 illustrates an example system 100 for generating hydrogen on demand. In one embodiment, system 100 includes an electrolysis subsystem 180 and a hydrogen production subsystem 190.

Electrolysis subsystem 180 includes the components useful for producing sodium metal, hydrogen, and chlorine gas from sodium chloride. Subsystem 180 includes a salt material 112, an electrical source 114, a heating apparatus 116, and an electrolysis vessel 122.

Salt material 112 includes sodium chloride and optionally any salt or transition metal, or non-metal that can be used to facilitate melting the sodium chloride or performing electrolysis of the sodium chloride. For example calcium chloride is used in the nuclear power industry to lower the melting temperature of sodium chloride when producing sodium. The ratio may be fifty percent of both salts.

System 100 is operable for delivering a salt material 112 to an electrolysis vessel 122. Electrolysis vessel is configured to hold salt material 112 and heat salt material 112 via heating apparatus 116. The melting of sodium chloride can occur within electrolysis vessel or outside electrolysis vessel. FIG. 1A shows the configuration where salt material 112 is melted in the electrolysis vessel. However, those skilled in the art will appreciate that all or a portion of the heating to cause salt material 112 to melt can be performed outside vessel 122.

Heating apparatus can be any device capable of generating sufficient heat to melt salt material 112. In one embodiment, heating apparatus can be a solar collector, such as, but not limited to a parabolic solar collector. The parabolic solar collector may be a solar trough, but higher temperatures can be achieved from sun light using a magnifying glass type lens. A specific example of a heating apparatus suitable for use in the present invention includes, but is not limited to the commercially available solar dish and associated Stirling motor available from Sun Machine of Germany.

In an alternative embodiment, system 100 can include a green steam boiler. The source of heat in this embodiment may be derived from dry vegetative matter or other organic matter, such as, but not limited to wood chips or other woody material. A green steam engine can be used alone or in combination with one or more other heat sources. An example of suitable steam engine is described in U.S. Pat. No. 6,647,813, which is hereby incorporated herein by reference. In one embodiment, the heat from an organic source such as wood pellets can be used in combination with a solar source. In this embodiment, the steam boiler is used intermittently when solar collection is insufficient.

Subsystem 180 also includes an electrical source 114. Electrical source 114 can be any power source including, but not limited to, a solar cell, wind mill, geothermal generator, hydroelectric power, a fuel cell and/or a power grid. Electrical source 114 provides the power needed to perform electrolysis of a molten salt material. The electrical source can also be used in addition to or alternatively to heating apparatus 116 to melt the salt. Electrical source 114 can be used to melt salt material 112 using, for example, an electrical heating element. In one embodiment, electrical source 114 may be a parabolic dish. The parabolic dish can include a drive mechanism that will follow the sun to keep the dish producing electrical energy during the daytime hours (i.e., as the sun moves across the sky).

Subsystem 180 can include any number of electrical sources 114 and/or heating apparatuses useful for melting and/or performing electrolysis of the salt material.

In one embodiment, the source of the power can be from hydrogen produced in system 100. Using the hydrogen produced in the system reduces the efficiency of the system 100, but can be advantageous where the heating apparatus 116 and/or electrical source 114 become temporarily unavailable. During periods in which the heating source and/or the electrical source are non-producing, the energy of the system may be derived from stored energy and the redox potential of aluminum.

Electrolysis is carried out in vessel 122 by applying a voltage across a solution of salt material. Electrolysis vessel 122 includes a cathode 118 and an anode 120 coupled to electrical source 114. Electrolysis vessel 122 includes an outlet for chlorine gas 124 and an outlet for sodium metal 132.

Electrolysis vessel can include any number of features and components for carrying out electrolysis using techniques and knowledge known to those skilled in the art.

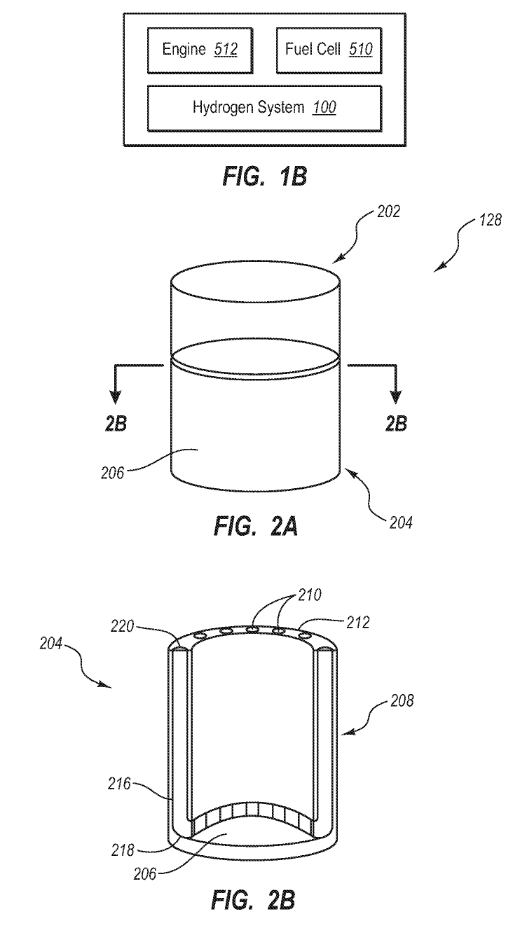

As mentioned system 100 includes reactions subsystem 190. Subsystem 190 includes water storage 134 and first and second mixing vessels 128 and 129, respectively. First mixing vessel 128 is configured to receive sodium metal produced in subsystem 180. First mixing vessel is also configured to receive water from storage 134. Water and sodium are reacted together in first mixing vessel to produce hydrogen gas 126 and sodium hydroxide 136. Additional details regarding first mixing vessel 128 are described in more detail below with regard to FIGS. 2A-2C. Second mixing vessel 129 is configured to receive hydrogen gas 126 from first reaction vessel 128 and chlorine gas 124 from subsystem 180 and react these components with water from water storage 134 to produce hydrochloric acid 150. Those skilled in the art are familiar with suitable mixing vessels for reacting hydrogen gas, chlorine gas, and water to form hydrochloric acid (HCl).

Subsystem 190 also includes production chambers 140 and 144. Production chamber 140 is configured to receive sodium hydroxide 136 from first mixing vessel 128 and/or from auxiliary sodium hydroxide supply 135. Production chamber 140 is also configured to receive aluminum from aluminum source 138. Aluminum from source 138 reacts with sodium hydroxide to produce hydrogen stream 156.

The aluminum from source 138 is typically solid aluminum. Aluminum 138 can be provided in any form, including, but not limited to aluminum pellets. In one embodiment, the aluminum is packaged or housed so as to exclude air and/or oxygen, which can cause undesired oxidation of the aluminum. In one embodiment, the aluminum can be provided in a sealed plastic packaging and immediately injected from its sealed packaging into the production chamber upon use. In one embodiment, the reactive materials, (e.g., sodium, aluminum, HCl, and NaOH) are kept inert until used, which provides a desired level of safety.

The reaction of the aluminum with the sodium hydroxide immediately creates pressure. In one embodiment, the pressure of hydrogen stream 156 can be controlled using a piston 142. The pressure in production chamber 140 can be modified by changing the volume of production chamber 140 using piston 142. Increasing the volume of chamber 140 reduces the pressure approximately according to the ideal gas law, which is PV=nRT, where P is pressure, V is the volume of chamber 140, n is the number of moles of gas, R is the gas constant and T is temperature. Hydrogen stream 156 can be delivered to a hydrogen mixing or storage apparatus 148, to be temporarily stored or mixed with hydrogen stream 158 from production chamber 144.

Production chamber 144 is configured to receive aluminum from aluminum source 138 and hydrochloric acid from second mixing vessel 129 and/or auxiliary hydrochloric acid supply 151. The hydrochloric acid and aluminum react in production chamber 144 to produce hydrogen, which exits as hydrogen stream 158. Production chamber 144 can have a controllable volume using piston 146. Piston 146 can operate similarly or differently than piston 142. In an alternative embodiment, production chambers 140 and 144 can be a single chamber and pistons 142, and 146 can be form a single piston. In this embodiment, HCl and NaOH can alternately be producing hydrogen and creating pressure on one side and pushing hydrogen and waste material out the other side. If the piston is connected to a fly wheel and if the alternating cycle is fast enough, the piston can be used to perform the function of a motor and/or electrical generator.

Controlling the pressure of hydrogen stream 156 can be useful for providing a constant hydrogen gas supply to a fuel cell and/or a combustion motor. In one embodiment, the pressure in hydrogen apparatus 148 is maintained at a constant pressure or within a desired range of pressure by controlling the pressures of hydrogen streams 156 and 158 in unison. The desired pressure can be maintained by the timing that reactants are brought into contact in production chambers 140 and 144 and/or by controlling the volumes in production chambers 140 and 144.

In one embodiment, system 100 may also include an auxiliary supply of reactants to use in the event that subsystem 180 is unavailable. In one embodiment, auxiliary supplies 135 and 151 are used intermittently or available in the event of an emergency or in the event of a large travel distance (e.g. in the embodiment where system 100 is incorporated into a vehicle). The auxiliary supplies can be in the same form or a different form than sodium hydroxide and hydrochloric acid received from first and second mixing vessels 128 and 129. In addition, system 100 can have either one or both of the auxiliary supplies and the auxiliary supplies can be used alone or in combination with one another. In addition, production chambers 140 and 144 can be used independently or in combination. Many industries produce commercial hydrochloric acid and/or sodium hydroxide (caustic soda) which can be used in the auxiliary systems described herein, but usually at higher cost.

Production chambers 140 and 144 are also configured to expel waste production to waste storage bins 154 and 152, respectively. Waste storage bins can be made of any material suitable for handling the waste products of the reaction carried out in production chambers 140 and 144, as described more fully below.

Hydrogen from system 100 can be delivered to any power generating apparatus to convert the hydrogen into electrical power or work. In one embodiment, hydrogen from system 100 can be burned in an internal combustion engine connected to an electrical generator and/or delivered to a fuel cell for electrical power generation. FIG. 1B illustrates system 100 incorporated into a larger system 500 that includes an engine 512 and a fuel cell 510.

System 100 can be a fixed system in which the components are relatively immobile. For example the components of system 100 can be housed in a building or other affixed structure. Alternatively, hydrogen system 100 can be incorporated into a mobile structure. For example, system 500 can be any vehicle, such as, but not limited to, a car, truck, airplane, boat or train and system 500 can include hydrogen system 100 described above. System 500 can include one or both of engine 512 or fuel cell 510. In one embodiment, engine 512 is an internal combustion engine configured to burn the hydrogen. In an alternative embodiment, engine 512 can be an electrical motor. In one embodiment, fuel cell 510 can produce electricity from hydrogen from system 100 and use the electricity to power an electrical motor 512.

FIGS. 2A-2C describe a particular implementation of a first mixing vessel 128. Mixing vessel 128 can include an upper portion 202 and a lower portion 204. Lower portion 204 includes a vessel configured to hold a fluid such as water. As shown in FIG. 2B, illustrates lower portion 204 including void 206 defined by a wall 208. Wall 208 includes a plurality of elongate channels 210 that extend from an upper end 212 to a lower end 214 of wall 208. At least a portion of elongate channels 210 are at least partially filled with sodium metal 218. Elongate channels 210 include an internal opening 218 that opens toward the inside of apparatus 204 (i.e., within void 206). Elongate channels 210 also include a second opening 220 at the upper end 212. Sodium metal 216 is introduced into elongate channels 210 through opening 220 and exits through opening 218.

Elongate channels 210 can have any shape suitable for flow of sodium metal. In one embodiment, elongate channels are tubular.

Upper portion 202 of mixing vessel 128 includes injection components for injecting sodium metal 218 into water stored within the vessel. In one embodiment, upper portion 202 can include pumps, fluids, and/or plungers or hydraulic pressure or pneumatic pressure for providing pressure to sodium 218 so as to inject the sodium into void 206 where it can react with water. Upper portion 202 can also be configured to receive sodium metal from subsystem 180 and place the sodium metal in elongate chambers 210. Upper chamber 202 is unnecessary when hydraulic or pneumatic pressure is used.

The volume of elongate chambers provides a storage mechanism for ensuring a constant and uninterrupted supply of sodium metal. The sodium metal can be injected into the vessel in discrete amounts to ensure desired concentrations for the sodium hydroxide. In one embodiment, injection is achieved by rotating bottom portion 204 relative to upper portion 202. The injection apparatus of upper portion 202 rotates to successive holes elongate channels 210 as the upper and lower portions are rotated relative to one another. The rotation can also be used to position a loading apparatus to reload empty elongate channels with sodium metal.

In one embodiment, the sodium metal can be packaged into a plastic sleeve that protects the sodium from reacting with moisture until it is injected into the void 206 of vessel 128 (i.e., when it is injected into the water). In one embodiment, the packaging divides the sodium metal into fractions that provide discrete volumes of sodium. The discrete volumes can be used to ensure proper concentrations of sodium hydroxide for delivery to the production chamber; and, keep the remaining sodium inert from reacting with the water.

In an alternative embodiment, packaging the sodium metal is not required. In this embodiment, opening 218 can include a one way valve to prevent water from reaching sodium 218 within vessel wall 208. Alternatively the internal opening 218 can be positioned at the top end 212 and the opening 220 can be position at the bottom end 214.

II. Methods for Generating Hydrogen

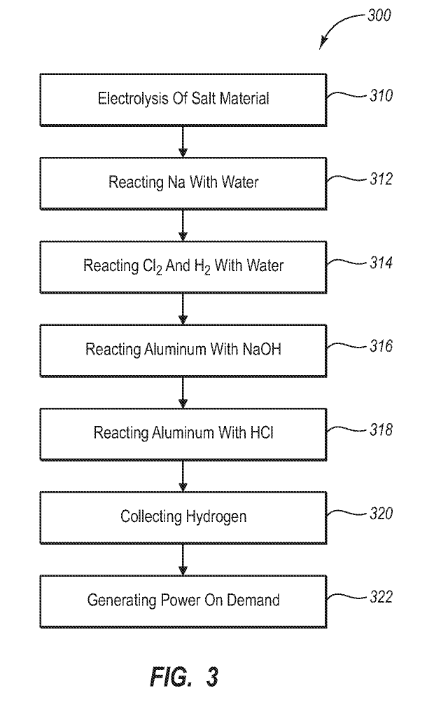

The present invention also includes methods for producing hydrogen and using that hydrogen to generate power on demand. FIG. 3 describes a method 300, which includes a first step of performing electrolysis of a salt material. The salt material includes sodium chloride and is melted to form a molten salt. In one embodiment, the temperature to melt the salt material is in a range from about 300° C. to about 1000° C., alternative in a range from about 500° C. to about 1000° C., or even 700° C. to about 1000° C. A voltage is applied across the molten salt to create sodium metal and chlorine gas. Chlorine gas is collected at the anode and sodium is collected at the cathode. The reaction for step 310 proceeds according to Equation 1.

2NaCl+Heat+electricity=>2Na+Cl₂ [Equation 1]

The process of the present invention can be economic because the primary component, salt, is inexpensive. In one example, 10 pounds of salt that undergoes electrolysis yields 3.94 pounds of Na and 6.07 pounds of Cl. The energy to perform the electrolysis can be inexpensive as well if solar, wind, wood or even initial hydrogen is used.

In step 312, the sodium metal produced in step 310 is reacted with water to produce sodium hydroxide and hydrogen. The reaction for step 312 proceeds according

2Na+2H₂O=>2NaOH+H₂ [Equation 2]

In step 314, the hydrogen produced in step 312 can be reacted with the chlorine gas produced in step 310 to yield hydrochloric acid. The reaction for step 314 proceeds according to Equation 3. Hydrogen gas and chlorine gas readily dissolve in water.

H₂+Cl₂+H₂O=2HCl_{aq} [Equation 3]

In step 316, solid aluminum is reacted with the sodium hydroxide from step 312 to produce hydrogen and an aluminum waste product. The reaction for step 316 proceeds according to Equation 4.

2Al+2NaOH+6H₂O=>2AlNa(OH)₄+3H₂ [Equation 4]

In step 316, the sodium hydroxide is preferably mixed with the aluminum in a ratio that produces a desired ratio of products. In one embodiment, step 316 may carried out by reacting aluminum and sodium hydroxide in a molar ratio in a range from about 2:1 to about 1:2, more preferably in a ratio of about 1:1. (Eventually molar ratios may be achieved, but incremental, small amounts of added aluminum generate hydrogen in substantial quantities very rapidly, and there is heat that is added to the system).

In step 318, solid aluminum is reacted with the hydrochloric acid produced in step 314. The reaction for step 318 proceeds according to Equation 5.

2Al+6HCl=>2AlCl₃+3H₂ [Equation 5]

In step 318, the sodium hydroxide is preferably mixed with the aluminum in a ratio that produces a desired ratio of products. In one embodiment, step 318 may carried out by reacting aluminum and hydrochloric acid in a molar ratio of Al:HCl in a range from about 1:4 to about 1:2, more preferably in a ratio of about 1:3. (Eventually molar ratios may be achieved, but incremental, small amounts of added aluminum generate hydrogen in substantial quantities, very rapidly, and there is heat that is added to the system).

Equations 4 and 5 both produce 3 moles of hydrogen for 2 moles of aluminum. Aluminum can be used in steps 316 and 318 because aluminum is amphoteric, meaning it can be oxidized using an acid, HCl, and reduced using a base, NaOH. In both processes, the redox reactions produce quantities of Hydrogen, which is collected in step 320 and used as a source of electrical or mechanical power in step 422.

Method 300 can be used to generate hydrogen on demand. Steps 310-318 include the production of intermediate compounds that can be formed at a desired rate to ensure a desired rate of production of hydrogen. In one embodiment, the rate of performing steps 310-318 is carried out so as to produce a continuous stream of hydrogen for at least about 10 minutes, more preferably at least about 30 minutes and most preferably for at least 1 hour. (The reaction is very quick; eventually molar ratios may be achieved, but incremental, small amounts of added aluminum generate Hydrogen in substantial quantities very rapidly, and there is heat that is added to the system). In one embodiment, the “demand” determines the pressure, the rate and the duration, time, and the number of parallel methods and systems operating at any given time to produce hydrogen.

In an alternative embodiment, a method 400 can be carried out using a salt solution. In step 412, aqueous NaCl is submitted to electrolysis to produces H₂ at the anode and Cl₂. The solution can be evaporated leaving solid NaOH, sodium hydroxide, as a residue powder, and sometimes solid pieces of caustic soda. The reaction can be performed at room temperature, although higher temperatures can also be used. Because the sodium chloride is not melted, this embodiment can be carried out with a system similar to system 100 but that omits heating apparatus 116 if desired.

This reaction for electrolysis of a salt solution is provided in Equation 6.

2NaCl+2H₂O+elect=>H₂+Cl₂+2NaOH [Equation 6]

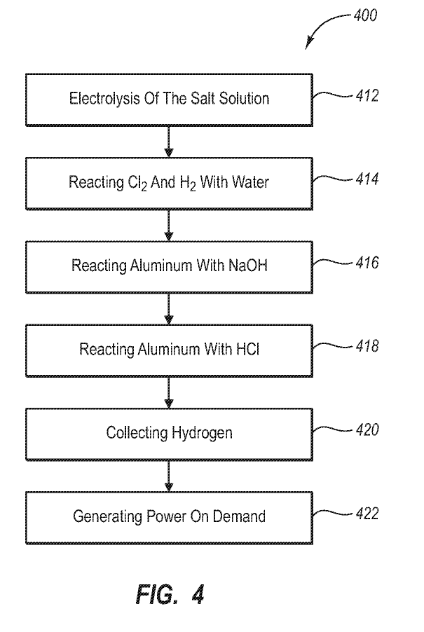

In step 414 the hydrogen and chlorine gas from electrolysis are reacted with water to form hydrochloric acid. In this embodiment, the hydrogen for forming hydrochloric acid is provided by the electrolysis rather than the reaction of sodium with water as described above with respect to FIGS. 1-3. In the embodiments described with respect to FIG. 4, no sodium metal is formed. This embodiment can be carried out using a system similar to system 100 except that the first mixing apparatus 128 is omitted and NaOH produced in reaction vessel 122 is delivered directly to production chamber 140. In step 416, aluminum is reacted with the sodium hydroxide from electrolysis and produces hydrogen gas and AlNa(OH)₄. In step 418, aluminum is also reacted with HCl to produce hydrogen gas and AlCl₃. In steps 420 and 422, the hydrogen is collected and used to generate power. The ability to temporarily store the hydrochloric acid and set the parameters for electrolysis of the salt solution, method 400 can be used to produce hydrogen on demand.

The present invention may be embodied in other specific forms without departing from the described chemical reactions or essential characteristics thereof. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for generating hydrogen, comprising:
a salt material including sodium chloride, salt;
a heating apparatus capable of generating sufficient heat to melt the salt material;
an electrolysis vessel configured to receive melted salt material, the electrolysis vessel including electrodes coupled to an electrical source and configured to perform electrolysis of the sodium chloride to produce sodium metal and chlorine gas;
a first mixing chamber configured to receive water and sodium metal to produce hydrogen and sodium hydroxide;
a second mixing chamber configured to receive water, the hydrogen gas, and the chlorine gas to produce hydrochloric acid;
a source of aluminum;
a hydrogen production apparatus including,
a first production chamber configured to receive and react aluminum and sodium hydroxide to form hydrogen and AlNa(OH)₄; and
a second production chamber configured to receive and react aluminum and hydrochloric acid to form hydrogen and AlCl₃; and hydrogen flow system for delivering the hydrogen to a power generating apparatus.

2. A system as in claim 1, wherein the electrical source includes a solar collector.

3. A system as in claim 2, wherein the solar collector is a parabolic solar collector.

4. A system as in claim 2, further comprising an alternative electrical generator configured to generate electricity for electrolysis of the salt material if the solar collector produces insufficient power for electrolysis.

5. A system as in claim 4, wherein the alternative electrical generator is a green steam engine.

6. A system as in claim 1, wherein the hydrogen production chamber includes one or more pistons that can be moved to change the volume of the first and second production chambers so as to increase or reduce the partial pressure of hydrogen within the first and second production chambers, and eject hydrogen to be used on demand.

7. A system as in claim 1, further comprising an alternative reservoir of sodium hydroxide and/or hydrochloric acid, wherein the alternative reservoir is operably coupled to the hydrogen production apparatus and capable of providing an emergency supply of sodium hydroxide and/or hydrochloric acid.

8. A transportation vehicle comprising the system of claim 1, wherein the power generating apparatus is an internal combustion motor or a fuel cell.

9. A system as in claim 1, wherein the system is stationary and electrically coupled to a home or business establishment.

10. A system as in claim 7, further comprising an electrical connection to an electric grid system and configured to off-load excess power to the grid system.

11. A method for generating hydrogen on demand, comprising
melting a salt material that includes sodium chloride;
performing electrolysis of the melted material to produce sodium metal, hydrogen, and chlorine gas;
reacting the sodium metal with water to produce sodium hydroxide;
reacting the chlorine gas and hydrogen with water to produce hydrochloric acid;
in a first chamber, reacting aluminum with the sodium hydroxide to form hydrogen and AlNa(OH)₄;
in a second chamber, reacting aluminum with the hydrochloric acid to form hydrogen and AlCl₃; and
recovering at least a portion of the hydrogen.

12. A method as in claim 11, wherein the sodium metal is reacted with the water by injecting a discrete volume of sodium into a chamber to produce hydrogen over a period of at least about 10 minutes.

13. A method as in claim 11, further comprising consuming the hydrogen to produce electricity or mechanical power.

14. A method as in claim 11, wherein the aluminum is injected into the plurality of chambers in discrete quantities.

15. A method as in claim 14, wherein the aluminum and sodium hydroxide are injected into the first reaction chamber in a molar ratio in a range from about 2:1 to about 1:2.

16. A system for on-demand production of sodium hydroxide from sodium metal, the system comprising:
a sodium module including a plurality of elongate channels, each channel having a first end and a second end and sodium metal disposed therein;
a reaction vessel including water and being in fluid communication with the second opening of at least one elongate channel;
a dispensing apparatus operably coupled to the first opening of the at least one elongate channel, wherein the dispensing apparatus is operable to inject a measured quantity of sodium from the elongate channel into the water of the reaction vessel so as to produce a measured quantity of sodium hydroxide in the reaction vessel.

17. A system as in claim 16, wherein the sodium module is disposed in a wall of the reaction vessel.

18. A system as in claim 16, wherein the elongate channels are tubular.

19. A system as in claim 16, wherein the dispensing apparatus further comprises a pressurized fluid that causes injection of the measured quantity of sodium into the water of the reaction vessel.

20. A system as in claim 16, further comprising a production chamber, wherein the sodium hydroxide produced in the reaction vessel is delivered to the production chamber and reacted with aluminum to produce hydrogen, the production chamber including an outlet for the hydrogen produced therein.
